(19) United States
(12) Patent Application Publication
(10) Pub. No.: US 2025/0098716 A1
(43) Pub. Date: Mar. 27, 2025

(54) Oat Flour-Based Créme Confection

(71) Applicant: General Mills, Inc., Minneapolis, MN (US)

(72) Inventors: Karmin Bryant, Minneapolis, MN (US); Scott Paben, Maple Grove, MN (US); Morgan Redemann, Minneapolis, MN (US); Jill A. Statt, Edina, MN (US)

(73) Assignee: General Mills, Inc., Minneapolis, MN (US)

(21) Appl. No.: 18/888,571

(22) Filed: Sep. 18, 2024

Related U.S. Application Data
(60) Provisional application No. 63/539,965, filed on Sep. 22, 2023.

(51) Int. Cl. A23L 7/10; A21D 2/16; A21D 13/047; A21D 13/19; A21D 13/28; A21D 13/38; A23K 10/30; A23K 40/30; A23K 50/40

(52) U.S. Cl. CPC A23L 7/198; A21D 2/165; A21D 13/047; A21D 13/19; A21D 13/28; A21D 13/38; A23K 10/30; A23K 40/30; A23K 50/40

(57) ABSTRACT

Described herein is a food composition that is suitable for use as a filling or topping for a shelf stable snack. The food composition includes an oat flour in an amount of 30-50%, a fat component that includes a shortening and an oil, sugar, a total moisture content of 2.5-5%, and a water activity of less than 0.58. The food has an extended shelf life at room temperature and resists moisture migration despite containing a significant amount of oat flour, which has a moisture content of 6-10%.

### BACKGROUND

This application claims priority to U.S. Provisional Patent Application Ser. No. 63/539,965 filed Sep. 22, 2023, the entire disclosure of which is incorporated herein by reference.

Consumers enjoy new eating experiences. Consumers particularly enjoy texture attributes of nut butters, including creaminess and mouth coating, that are characteristic of nut butters. New eating experiences that are reminiscent of nut butters, but present different flavor and/or nutritional profiles, are needed.

### SUMMARY

The present disclosure relates to oat butter compositions, food products that contain such compositions, and methods of making oat butter compositions and food products containing such compositions.

A food composition is provided herein. The food composition includes oat flour in an amount of about 30% to about 50% by weight of the food composition, the oat flour having a moisture content of 6% to 10%; a fat component, where the fat composition includes a shortening in an amount of about 18% to about 35% by weight of the food composition, the shortening having a Mettler Dropping Point (MDP) of from about 40° C. to about 50° C., and an oil in an amount of about 7% to about 10% by weight of the food composition, where the oil to shortening is at a ratio of from about 0.2:1 to about 0.5:1; sugar in an amount of about 15% to about 25% by weight of the food composition; a total moisture content of about 2.5% to about 5% by weight of the food composition; and a water activity of less than 0.58. The oat flour can be included in an amount by weight that is greater than the amount of the shortening.

In some embodiments, the shortening has a 10° C. to 40° C. solid fat content (SFC₁₀₋₄) profile, the SFC₁₀₋₄₀ profile having a formula of y=mx+b, where
y is solid fat content,
x is temperature in Celsius,
m is slope having a value between about −1.5 and about −2.2, and
b is a value between about 70 and about 90.

In some embodiments, the shortening has a rate of crystallization (ROC) measured between 30 seconds and 300 seconds having a formula of y=mx+b, where
y is solid fat content,
x is time in seconds,
m is slope having a value of about 0.01 to less than 0.2, and
b is a y-intercept having a value between about 5 and about 20.

In some embodiments, the shortening can include palm oil and/or a hydrogenated fat.

In some embodiments of a food composition provided herein, sugar can be included in an amount of about 16% to about 20% by weight of the food composition.

A food composition can optionally include a natural sweetener.

A food composition can optionally include a polysaccharide, such as starch, in an amount of about 0.5% to about 12% by weight of the food composition.

A food composition provided herein can optionally be combined with a particulate to resemble a chunky oat butter.

A packaged food product is also provided herein. A packaged food product includes comprising a base piece, such as a cookie, a biscuit, or a wafer, and a food composition provided herein (e.g., smooth or chunky oat butter).

In some embodiments, a food composition can be on at least a portion of a surface of the base food piece. In some embodiments, the food composition can be layered between two or more base pieces. In some embodiments, the food composition can be included as a filling inside the base piece.

In some embodiments, a packaged food product provided herein can be a pet food.

A method of making a food composition is also provided. A method includes combining ingredients to make a mixture, the mixture including: oat flour in an amount of about 30% to about 50% by weight of the mixture, the oat flour having a moisture content of 6% to 10%; a fat component, where the fat component includes a shortening in an amount of about 18% to about 35% by weight of the food composition, the shortening having a Mettler Dropping Point (MDP) of from about 40° C. to about 48° C., and an oil in an amount of about 7% to about 10% by weight of the food composition, where the oil to shortening is at a ratio of from about 0.2:1 to about 0.5:1; and sugar in an amount of about 15% to about 25% by weight of the food composition; processing the mixture using a scraped surface heat exchanger to make the food composition, the food composition having a total moisture content of about 2.5% to about 5% by weight of the food composition and a water activity of less than 0.58.

These and various other features and advantages will be apparent from a reading of the following detailed description.

### DETAILED DESCRIPTION

Nut butters and shelf stable nut butter-based fillings and toppings are compositions that are most stable at moisture contents of 1.5% to 2.5%. Outside this range, nut butters risk rancidity, increased microbial safety risk, and other problems over shelf life at room temperature. In addition, the low moisture content and low water activity (typically 0.20-0.30) of nut butter fillings and toppings reduces risk of moisture migration from the nut butter into other low moisture components of foods that contain such fillings or toppings, such as cookies, biscuits, and wafers.

It was discovered, and is disclosed herein, that a composition that texturally resembles a nut butter-based filling or topping can be made using oat flour as a major ingredient. Surprisingly, although oat flour has a significantly higher moisture content (typically around 6-10%, or about 8%) relative to roasted nuts and/or nut flours suitable for making a nut butter (typically less than 3%), the described compositions containing oat flour have a stable shelf life of at least 6 months (e.g., at least 8 months, or 8-12 months). Additionally, it was discovered that such a composition was structurally stable over shelf life, which was surprising because a peanut butter-based composition similarly formulated but including peanut butter and peanut flour would oil out over shelf life if the peanut flour was replaced with oat flour. As used herein, the term “stable shelf life” refers to stable structure, flavor, and texture, as well as food safety over the shelf life period at room temperature.

In addition, despite having a total moisture content of 2.5% to 5% by weight, the described oat butter compositions are resistant to moisture migration into other low moisture components, such as biscuits, wafers, or cookies, when combined with them as a topping or filling. As a result, an oat butter provided herein can be combined with, for example, a crispy wafer to make a food that has a dual crispy and creamy texture that is stable over shelf life. This is in contrast to other, commercially available oat butter products, which are not suitable for combining with other low moisture components to make shelf stable foods because moisture and/or oil migration from such oat butter products could result in negative attributes, such as sogginess of the other components.

A food composition provided herein, also referred to herein as an “oat butter,” includes oat flour in an amount of about 30% to about 50% (e.g., 30% to about 40%, or about 30% to about 38%) by weight of the composition. In some embodiments, oat flour is included in a food composition as the first ingredient by weight of the food composition. Such a high oat flour content was not expected to result in a shelf stable, moisture migration-resistant composition due to the amount of moisture that oat flour would contribute to such a composition. However, the present application describes a composition that avoids such drawbacks, and provides an oat butter with a nut butter-like texture. Oat flour content of at least 30% can help impart a good flavor to a food composition described herein and enables embodiments where oat flour contributes the highest content by weight of ingredients included in the oat butter.

A food composition provided herein includes a fat component. A fat component in an oat butter includes a shortening in an amount of from about 18% to about 35% (e.g., about 25% to about 33%) by weight of the food. A suitable shortening can have a Mettler Dropping Point (MDP) of from about 40° C. to about 50° C. (e.g., from about 42° C. to about 49° C.).

In some embodiments, a shortening can have a 10° C. to 40° C. solid fat content (SFC₁₀₋₄₀) profile having a formula of y=mx+b, where
y is solid fat content,
x is temperature in Celsius
m is a slope having a value between about −1.5 and about −2.2 (e.g., about −1.8 to
about −2.1), and
b is a value between about 70° C. and about 90° C. (e.g., about 75° C. to about 85° C.).

As used herein, a SFC₁₀₋₄₀ profile for a fat is determined by plotting solid fat content (SFC) values as a function of temperature, where the SFC values are measured at 10° C., 21.1° C., 26.7° C., 33.3° C., and 40° C., and fitting a line to the SFC values using least squares linear regression. The fitted line is the SFC₁₀₋₄₀ profile for the fat. SFC is measured by nuclear magnetic resonance (NMR) according to AOCS Cd 16b-93 (Firestone, D. (Ed.). (2009). Official Methods and Recommended Practices of the AOCS (6^{th} ed.). AOCS Press). A shortening having a described SFC₁₀₋₄₀ profile can contribute to a mouthfeel that is reminiscent of a nut butter without excessive waxiness.

In some embodiments, a shortening can have a 26.7° C. to 40° C. solid fat content (SFC₂₇₋₄₀) profile having a formula of y=mx+b, where
y is solid fat content,
x is temperature in Celsius
m is a slope having a value between about −1.2 and about −2 (e.g., about −1.4 to about −1.7), and
b is a value between about 60° C. and about 80° C. (e.g., about 65° C. to about 75° C.).

As used herein, a SFC₂₇₋₄₀ profile for a fat is determined by plotting solid fat content (SFC) values as a function of temperature, where the SFC values are measured at 26.7° C., 33.3° C., and 40° C., and fitting a line to the SFC values using least squares linear regression. The fitted line is the SFC₂₇₋₄₀ profile for the fat. A shortening having a described SFC₂₇₋₄₀ profile can resist melting and smearing during shelf life and transport.

A shortening suitable for use in a food provided herein can include any appropriate fat, oil, or combinations of fats and/or oils. In some embodiments, a shortening can include a palm oil, a palm kernel oil, soybean oil, any fraction thereof, or any combination thereof. For example, in some embodiments, a shortening can include a palm oil, a palm kernel oil and/or palm kernel stearin, and a palm oil stearin. In some embodiments, a shortening can include one or more fat and/or oil that is interesterified. For example, in some embodiments, a shortening can include a palm oil, a palm kernel oil or a coconut oil, a palm kernel stearin, and a palm oil stearin, where one or more of the palm oil, the palm kernel oil or coconut oil, the palm kernel stearin, and the palm oil stearin is interesterified.

A fat component in a food composition provided herein also includes an oil in an amount of about 7% to about 10% (e.g., about 8% to about 9%) by weight of the food composition. A suitable oil can have a Mettler Dropping Point (MDP) of less than 20° C. (e.g., less than 10° C., or from about −20° C. to about 5° C.). Any edible oil can be used, such as, for example, canola oil, olive oil, sunflower oil, soybean oil, cottonseed oil, peanut oil, and the like, or any combination thereof. In some embodiments, an oil can be included at a rate that provides an oil to shortening ratio of from about 0.2:1 to about 0.5:1 (e.g., about 0.22:1 to about 0.45:1).

In some embodiments, a fat component can include a hard fat, such as a stearin fraction of a fat (e.g., a single fractionated stearin, or a double fractionated stearin) and/or a fully hydrogenated fat. For example, in some embodiments, a fat component can include a single fractionated or double fractionated palm stearin, a fully hydrogenated soybean oil, a fully hydrogenated palm oil, fully hydrogenated cottonseed oil, fully hydrogenated canola oil, palm kernel oil, or the like, or any combination thereof.

A food composition provided herein includes sugar in an amount of about 15% to about 25% (e.g., about 16% to about 20%, or about 18% to about 20%) by weight of the food composition. As used herein, the term “sugar” refers to a monosaccharide or disaccharide, such as sucrose, fructose, glucose, and the like. In some embodiments, a sugar can comprise a crystalline (e.g., granulated or powdered) sugar, or a syrup (e.g., honey, maple syrup, corn syrup, or the like), or any combination thereof. In some embodiments, some or all of the sugar included in a food composition is a crystalline sugar.

In some embodiments, a food composition can include a non-sugar sweetener, such as a sugar alcohol, a fiber syrup (e.g., inulin), or a high intensity sweetener. In some embodiments, a non-sugar sweetener is a natural sweetener, such as stevia extract. In some embodiments, a food composition can comprise natural and/or artificial flavorants such as vanilla, fruit or vegetable powders, extracts, salt, cocoa, cinnamon, pepper, pet food palatants, and the like. A flavorant can contribute to any desirable flavor profile, including sweet or savory profiles, suitable for human or pet consumption. Typically, a non-sugar sweetener and/or flavorant is included in an amount of less than 15% by weight.

In some embodiments, a food composition provided herein can include a filler, such as a polysaccharide (e.g., starch or maltodextrin). A filler can be included in an amount of up to 18% (e.g., from about 0.5% to about 17%, about 1% to about 16%, about 3% to about 15%, about 5% to about 12%, or about 7% to about 10%) each, by weight of the food composition.

Additional ingredients can be included in a food provided herein. For example, emulsifiers (e.g., lecithin, or the like), colorants (e.g., extracts, fruit and/or vegetable juices, dyes, and the like), and the like, or any combination thereof, can be included in a food article provided herein. Additional ingredients can be included in a total amount of less than 8% (e.g., less than 5%, or less than 2%).

A food composition provided herein has a total moisture content of about 2.5% to about 5% by weight, as analyzed using Karl Fischer analysis (American Oil Chemists' Society Official Method Ca 2e-84 (2017). In contrast, nut butter-based compositions typically have a moisture content of less than 2% to ensure flavor stability over shelf life. A food composition provided herein has a water activity (A_{w}) of less than 0.58 (e.g., 0.56 or less, less than 0.40, less than 0.37, or from about 0.330 to about 0.55, or about 0.330 to about 0.45). Nut butter-based compositions typically have a water activity of about 0.200 to 0.300.

Despite having a moisture content higher than most nut butter-based compositions, and in some embodiments, an A_{w} higher than many nut butter-based compositions, a food composition provided herein still has a stable shelf life at room temperature of at least 6 months. In addition, a food composition can be combined with other food components having a low moisture content and/or water activity with little to no water migration over shelf life. For example, a food composition provided herein can be applied to a surface of a wafer base food piece to produce a packaged food product that essentially retains the original moisture and A_{w} of each of the components separately, resulting in a wafer that remains crispy and an oat butter that remains creamy over a stable shelf life of at least 6 months. A food composition provided herein can similarly be combined as a topping, coating, and/or filling on a number of other base food pieces, such as cookies, crackers, biscuits, pet food, and the like.

In some embodiments, a food composition can be combined with a particulate. Any suitable particulate can be used, such as dried fruits, dried vegetables, nuts, seeds, grains, chocolate pieces, compound pieces, candy pieces, coffee bean pieces, dried meats, and the like, or any combination thereof. A particulate can be selected to provide a desired textural, visual, and/or nutritional profile. If a particulate is combined a food composition, water migration to or from the food composition and the particulate may also be limited.

A food composition provided herein can be packaged alone or combined with a base food piece or particulates in any suitable packaging, such as a wrapper, a jar, a pouch, or a bag. Any packaging materials suitable for use for food, such as foil, plastic, and paper can be used.

Any appropriate method and equipment can be used to make a food composition provided herein. Ingredients used to make a food composition provided herein can be combined in any suitable order to produce the food composition. In some embodiments, ingredients of a food composition can be combined in a scraped surface heat exchanger to produce the food composition. In some embodiments, a fat component can be heated to a temperature sufficient to ensure softening or melting of the fat component before being combined with the remaining ingredients. Generally, methods and conditions of making a food provided herein can be designed to render the food, or ingredients or combinations of ingredients used to make the food, suitable for use in a food manufacturing setting. For example, a method of making a food provided herein can be designed to ensure that the food, ingredients used to make the food, or combinations of ingredients used to make the food are pumpable using standard food manufacturing equipment.

A food provided herein can be applied as a topping or a filling for a shelf stable snack food using any appropriate equipment and method. For example, a food provided herein can be extruded onto a snack food piece, or coextruded within a dough to form a filling.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A food composition, comprising:
a. oat flour in an amount of about 30% to about 50% by weight of the food composition, the oat flour having a moisture content of 6% to 10%;
b. a fat component, comprising:
i. a shortening in an amount of about 18% to about 35% by weight of the food composition, the shortening having a Mettler Dropping Point (MDP) of from about 40° C. to about 50° C.; and
ii. an oil in an amount of about 7% to about 10% by weight of the food composition, where the oil to shortening is at a ratio of from about 0.2:1 to about 0.5:1;
c. sugar in an amount of about 15% to about 25% by weight of the food composition;
d. a total moisture content of about 2.5% to about 5% by weight of the food composition; and
e. a water activity of less than 0.58.

2. The food composition of claim 1, wherein the oat flour is included in an amount by weight that is greater than the amount of the shortening.

3. The food composition of claim 1, wherein the shortening has a 10° C. to 40° C. solid fat content (SFC₁₀₋₄₀) profile, the SFC₁₀₋₄₀ profile having a formula of y=mx+b, where
y is solid fat content,
x is temperature in Celsius,
m is slope having a value between about −1.5 and about −2.2, and
b is a value between about 70 and about 90.

4. The food composition of claim 1, wherein the shortening has a rate of crystallization (ROC) measured between 30 seconds and 300 seconds having a formula of y=mx+b, where
y is solid fat content,
x is time in seconds,
m is slope having a value of about 0.01 to less than 0.2, and
b is a y-intercept having a value between about 5 and about 20.

5. The food composition of claim 1, wherein the shortening comprises palm oil.

6. The food composition of claim 1, comprising sugar in an amount of about 16% to about 20% by weight of the food composition.

7. The food composition of claim 1, comprising a natural sweetener.

8. The food composition of claim 1, comprising starch in an amount of about 0.5% to about 12% by weight of the food composition.

9. The food composition of claim 1, wherein the fat component comprises a hydrogenated fat.

10. A composition comprising the food composition of claim 1 combined with a particulate.

11. A packaged food product comprising a base piece and a food composition of claim 1.

12. The packaged food product of claim 11, wherein the food composition is on at least a portion of a surface of the base food piece.

13. The packaged food product of claim 12, wherein the base food piece is a cookie, a biscuit, or a wafer.

14. The packaged food product of claim 12, wherein the food composition is layered between two or more base pieces.

15. The packaged food product of claim 11, wherein the food composition is included as a filling inside the base piece.

16. The packaged food of claim 11, wherein the packaged food product is a pet food.

17. A method of making a food composition, comprising:
a. combining ingredients to make a mixture, the mixture comprising:
i. oat flour in an amount of about 30% to about 50% by weight of the mixture, the oat flour having a moisture content of 6% to 10%;
ii. a fat component, comprising:
1. a shortening in an amount of about 18% to about 35% by weight of the food composition, the shortening having a Mettler Dropping Point (MDP) of from about 40° C. to about 48° C.; and
2. an oil in an amount of about 7% to about 10% by weight of the food composition, where the oil to shortening is at a ratio of from about 0.2:1 to about 0.5:1; and
3. sugar in an amount of about 15% to about 25% by weight of the food composition;
b. processing the mixture using a scraped surface heat exchanger to make the food composition, the food composition having a total moisture content of about 2.5% to about 5% by weight of the food composition and a water activity of less than 0.58.
